(19) United States
(12) Patent Application Publication
(10) Pub. No.: US 2009/0164180 A1
(43) Pub. Date: Jun. 25, 2009

(54) APPARATUS AND METHOD FOR MODELING MOS TRANSISTOR

(76) Inventor: Seok Yong KO, Bucheon-si (KR)

Correspondence Address: SALIWANCHIK LLOYD & SALIWANCHIK;A PROFESSIONAL ASSOCIATION, PO Box 142950, GAINESVILLE, FL, 32614, US

(21) Appl. No.: 12/265,813

(22) Filed: Nov. 6, 2008

(30) Foreign Application Priority Data
Dec. 24, 2007 (KR) 10-2007-0136537

(51) Int. Cl. G06F 17/10; G06G 7/62

(52) U.S. Cl. 703/2; 703/4

(57) ABSTRACT

Disclosed are an apparatus and a method for modeling a MOSFET (Metal-Oxide Semiconductor Field Effect Transistor). The method can include the steps of: establishing an equation and a variable that determine the driving current characteristics of the MOS transistor; generating a random number; converting the random number such that the random number has a value satisfying an equation of a rotated ellipse and determining a variation degree of the variable based on the value of the random number; and outputting driving current distribution of the MOS transistor by using the equation and the variation degree of the variable.

### CROSS-REFERENCE TO RELATED APPLICATION

The present application claims the benefit under 35 U.S.C. §119 of Korean Patent Application No. 10-2007-0136537, filed Dec. 24, 2007, which is hereby incorporated by reference in its entirety.

### BACKGROUND

Recently, semiconductor manufacturing technology continues to allow fabrication of semiconductor chips in smaller sizes. Such a semiconductor chip can improve the operational speed of electric appliances, such as a computer, a cellular phone, a disk player, etc., while enabling the electric appliances to be fabricated in a smaller size with a compact structure.

In order to fabricate the electric devices in a smaller size, internal elements of the electric devices must be fabricated in a small size. For instance, in order to obtain transistors having a smaller size, theoretical design modeling and simulation work thereof are necessary before the transistors are fabricated. In addition, the simulation result must be fed back into the design when designing semiconductor integrated circuits.

FIG. 1 is a view showing driving current distribution of a p-MOS and an n-MOS field effect transistor obtained by measuring the driving current after forming a plurality of p-MOS transistors and n-MOS transistors on a wafer.

In FIG. 1, Mea (°) represents measurement values of the driving current of the p-MOS and n-MOS transistors when a width W of a gate electrode is 10 μm, and a channel length L of the gate electrode is 0.18 μm.

A variety of models including the SPICE model, are available that allow a designer to take the driving current distribution of the p-MOS and n-MOS transistors shown in FIG. 1 into consideration during transistor design.

FIG. 2 is a view showing the 5-corner model and the statistical model, which are generally used in simulation of the driving current distribution of the p-MOS and the n-MOS transistors.

As shown in FIG. 2, the 5-corner model represents the driving current distribution by using five points.

The 5-corner model includes a TT (Typical) model in which the driving current of the n-MOS and p-MOS transistors has an average value, an FF (Fast-Fast) model in which the driving current of the n-MOS and p-MOS transistors has the maximum value, an SS (Slow-Slow) model in which the driving current of the n-MOS and p-MOS transistors has the minimum value, an FS (Fast-Slow) model in which the driving current of the n-MOS transistor has a high value and the driving current of the p-MOS transistor has a low value, and an SF (Slow-Fast) model in which the driving current of the n-MOS transistor has a low value and the driving current of the p-MOS transistor has a high value.

In addition, as shown in FIG. 2 by asterisks (*), the statistical model represents the driving current distribution similar to the actual driving current distribution. According to the statistical model, a random number is generated through a Monte Carlo scheme so that the driving current distribution obtained through the simulation can be similar to the actual driving current distribution obtained through measurement.

A designer must take the worst case and the best case into consideration when designing the n-MOS and p-MOS transistors.

However, the 5-corner model requires several modeling procedures (many SPICE model libraries) to confirm various worst cases and best cases, and the statistical model requires many Monte Carlo simulation processes.

### BRIEF SUMMARY

Embodiments of the present invention provide an apparatus and a method for modeling a metal oxide semiconductor (MOS) transistor.

According to an embodiment, an apparatus and a method for modeling a MOS transistor are provided, capable of easily verifying the worst case and the best case.

In an embodiment, an apparatus and a method for modeling a MOS transistor are provided, capable of verifying various worst cases and best cases through a smaller number of Monte Carlo simulation processes as compared with the related art.

According to an embodiment, there is provided a modeling method for verifying driving current characteristics of a MOS transistor through a SPICE program, the method comprising the steps of: establishing an equation and a variable that determine the driving current characteristics of the MOS transistor; generating a random number; converting the random number such that the random number has a value satisfying an equation of a rotated ellipse and determining a variation degree of the variable based on the value of the random number; and outputting driving current distribution of the MOS transistor by using the equation and the variation degree of the variable.

According to an embodiment, there is provided a modeling apparatus and article of manufacture for verifying driving current characteristics of a MOS transistor through a SPICE program, the modeling apparatus or article of manufacture can comprise: a computer readable medium, which is encoded with instructions used for executing processes that are performed by a computer to simulate the driving current characteristics of the MOS transistor, wherein an equation and a variable that determine the driving current characteristics of the MOS transistor are determined by the instructions encoded in the computer readable medium, a random number is generated in the computer readable medium, the random number is converted such that the random number has a value satisfying an equation of a rotated ellipse, a variation degree of the variable is determined based on the value of the random number, and driving current distribution of the MOS transistor is output by using the equation and the variation degree of the variable.

### BRIEF DESCRIPTION OF THE DRAWINGS

FIG. 1 is a plot showing driving current distribution of p-MOS and n-MOS transistors;

FIG. 2 is a plot showing the 5-corner model and the statistical model, which are generally used in simulation of the driving current distribution of the p-MOS and the n-MOS transistors;

FIG. 3 is a block diagram of an apparatus for modeling a MOS transistor according to an embodiment; and

FIG. 4 is a view showing a simulation result obtained through a method for modeling a MOS transistor according to an embodiment of the present invention.

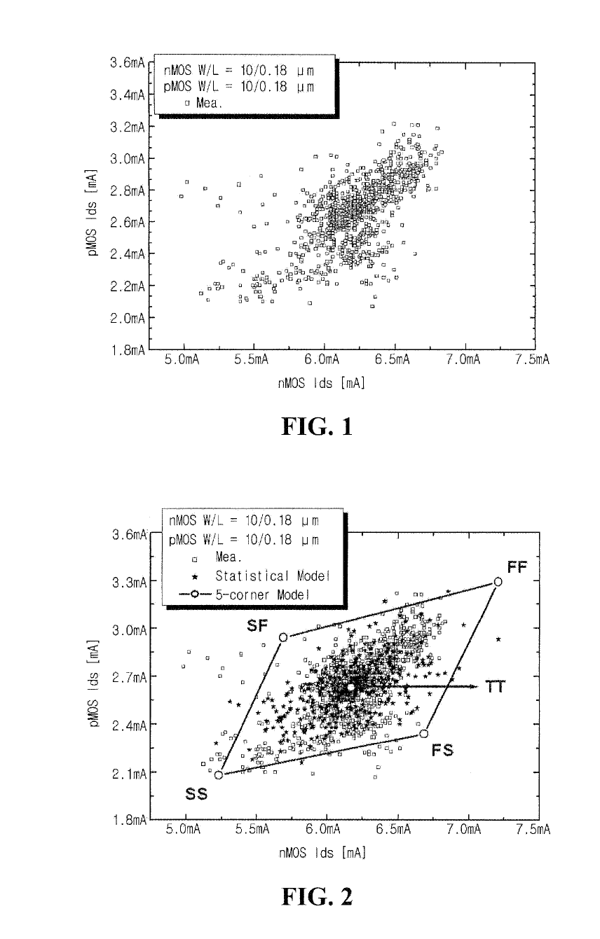

### DETAILED DESCRIPTION

Hereinafter, an apparatus and a method for modeling a MOS transistor according to an embodiment will be described with reference to accompanying drawings.

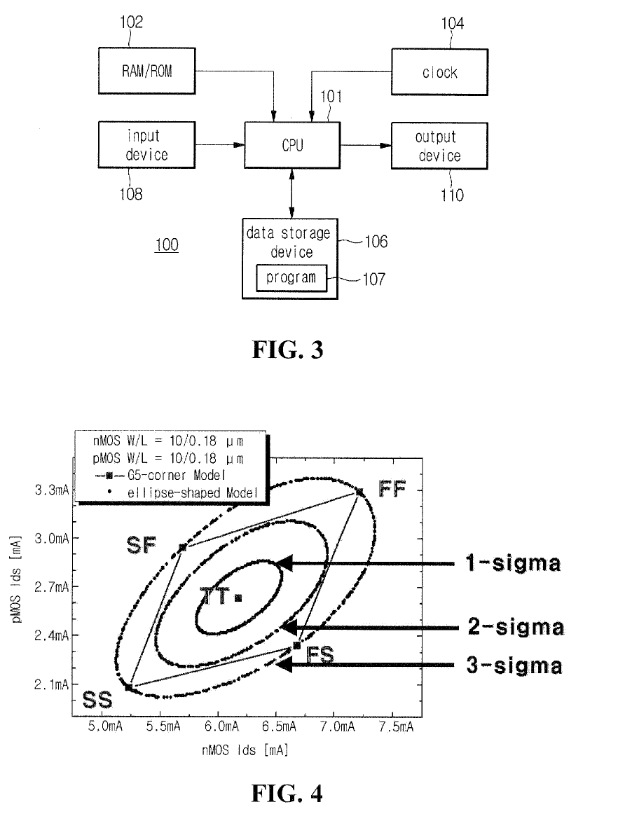

FIG. 3 is a block diagram showing an apparatus for modeling the MOS transistor according to an embodiment.

Referring to FIG. 3, the modeling apparatus 100 can be provided in the form of hardware of a computer system.

The modeling apparatus 100 receives program instructions and user's input; and outputs results corresponding to the instructions and user's input.

The modeling apparatus 100 can include a CPU (central processing unit) 101, such as a microprocessor available from Intel Corporation. The CPU 101 cooperates with RAM/ROM 102, a clock 104, a data storage device 106, an input device 108, and an output device 110.

RAM (Random Access Memory) includes memory modules having storage capacity sufficient for storing processing instructions used by the CPU 101. ROM (Read Only Memory) includes a permanent memory medium capable of storing instructions performed by the CPU 101 during the start routine of the modeling apparatus 100. Other functions of the RAM/ROM 102 are generally known in the art.

The clock 104 can be accommodated in the CPU 101 in order to regulate the clock speed when the CPU 101 synchronizes and performs communication with the above hardware elements of the modeling apparatus 100. Other functions of the clock 104 are generally known in the art.

The input device 108 includes at least one device that is available to a user and used to make communication with other computer systems or the modeling apparatus 100 based on one of the user's inputs. That is, the input device 108 can include, but is not limited to, a keyboard, a mouse, a scanner, a sound recognition unit, a serial/parallel communication port, a network suitable for network access and data reception, or a communication card. The input device 108 allows the user to input instructions and specific values.

The output device 110 includes at least one device that is available to a user and used to represent the results to the user of the modeling apparatus 100 according to the input instructions and specific values input by the user. That is, the output device 110 can include, but is not limited to, a display monitor, a speech synthesizer, a printer, a serial/parallel communication port, a network suitable for network access and data reception, or a communication card. The output device 110 allows the user to receive the results according to the instructions and specific values input by the user.

The data storage device 106 can be one of an internal mass-storage memory and an external mass-storage memory used for storing computer data. The storage capacity of the data storage device 106 can be above a Giga-byte. For instance, the data storage device 106 can store an operating system of Microsoft Corporation and least one application program, such as a program 107. That is, the data storage device 106 can be at least one of a hard disk drive, a CD-ROM disk and reader/writer, a DVD disk and reader/writer, a ZIP disk drive, and a computer readable medium which can be encoded with processing instructions of a read-only format or a read-write format. Other functions of the data storage device 106 and other available storage devices are generally known in the art.

The program 107 allows the modeling apparatus 100 to receive data and information and includes a plurality of processing instructions that can determine driving current characteristics of a MOSFET device.

According to an embodiment, the program 107 allows the worst case and the best case of the driving current characteristic to be distributed in the form of a rotated ellipse through Monte Carlo simulation processes based on a SPICE program, so that the designer can verify various worst cases and best cases.

Meanwhile, the driving current characteristics of the MOSFET device can be determined according to Equation 1.

$$Ids = Ueff \times Cox \frac{W}{L} ( Vgs - Vt - \frac{1}{2} Vds ) \times Vds \qquad Equation 1$$

In Equation 1, Ids is driving current, Ueff is effective mobility of an electron or a hole, Cox is capacitance per a unit channel area, W is a with of a gate electrode, L is a channel length of the gate electrode, Vgs is gate voltage, Vt is threshold voltage, and Vds is drain voltage.

According to an embodiment, the program 107 serving as the SPICE program can include the following lines of code.

| .LIB MCNO_018 | | |
|---|---|---|
| .param | | |
| + | psigma=abs(sig) sig=agauss(0,1,3) | [3-1] |
| + | pan=aunif(0,180) | [3-2] |
| + | px=‘3*cos(3.14159*pan/180)’ pa=2 pb=1 pr=1.5 | |
| | con=limit(0,1) | [3-3] |
| + | py=‘con*pb*sqrt(pr**2−(px**2)/(pa**2)’ | [3-4] |
| + | pang=‘3.141592*45/180’ | [3-5] |
| + | PN=‘(px*cos(pang)−py*sin(pang))/sin(pang)’ | |
| | PP=‘(px*sin(pang)+py*cos(pang))/sin(pang)’ | [3-6] |
| + | N_TOX=‘1.54e−10*(PN/3)*psigma’ | |
| | P_TOX=‘1.54e−10*(PP/3)*psigma’ | [3-7] |
| + | N_VTHO=‘9.00e−02*(PN/3)*psigma’ | |
| | P_VTHO=‘9.00e−02*(PP/3)*psigma’ | [3-8] |
| + | N_XL=‘1.20e−08*(PN/3)*psigma’ | |
| | P_XL=‘1.20e−08*(PP/3)*psigma’ | [3-9] |
| + | N_XW=‘2.20e−08*(−PN/3)*psigma’ | |
| | P_XW=‘2.20e−08*(−PP/3)*psigma’ | [3-10] |

In the above SPICE program, “.param” represents definition of parameters.

Equation [3-1] represents that “psigma” is an absolute value of a random number which is 3-sigma generated about 0 from a range of +1 to −1.

Equation [3-2] represents that “pan” is a value of a random number having uniform distribution in a range of 0 to 180.

Equations [3-3] and [3-4] represent that “px” is a parameter for an ellipse having a long diameter (pa) and a short diameter (pb) in a ratio of 2:1, and “con” is a function that repeats −1 and 1. The ellipse can be expressed by the elliptic equation in which an x-axis is 3 and a y-axis is 1.5.

Equations [3-5] and [3-6] are used to rotate the ellipse defined by Equations [3-3] [3-4] at an angle of 45 degrees.

Equations [3-7] to [3-10] are used to apply the rotated ellipse, which is defined by Equations [3-5] and [3-6], as a variable of main model parameters of the n-MOS and p-MOS transistors.

Referring to the above SPICE code and Equation 1, the driving current distribution for the MOS transistors can be obtained by changing N_TOX (n-MOS) and P_TOX(p-MOS) that are SPICE variables for Cox, N_VTHO and P_VTHO that are SPICE variables for Vt, N_XL and P_XL that are SPICE variables for L, and N_XW and P_XW that are SPICE variables for W.

In the embodiment, N_TOX and P_TOX that are parameters relating to variation of Cox, N_VTHO and P_VTHO that are parameters relating to variation of Vt, N_XL and P_XL that are parameters relating to variation of L, and N_XW and P_XW that are parameters relating to variation of W are used as variables in the simulation for the driving current distribution of the MOSFET device.

FIG. 4 is a view showing a simulation result obtained through a method for modeling a MOS transistor according to an embodiment of the present invention. As shown in FIG. 4, the simulation result represents that the driving current characteristic of the MOS transistor exists within the rotated ellipse.

In FIG. 4, 1-sigma, 2-sigma, and 3-sigma indicate ellipses when the “psigma” of Equation [3-1] is defined as 0.68, 0.95 and 0.99 (substantially 1), respectively. That is, 1-sigma, 2-sigma, and 3-sigma represent the worst cases and best cases when the actual MOS transistor has an error within a range of 1-sigma, 2-sigma, and 3-sigma, respectively.

Thus, various worst cases and best cases can be verified using one model by determining the value of “psigma” through the SPICE program.

If the value of “psigma” is defined as a specific value having 3-sigma of about 0 and selected from the range of −1 to +1, the driving current distribution can be expressed as a plurality of ellipses within the range of 3-sigma (ellipse) shown in FIG. 4.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A modeling method for verifying driving current characteristics of a MOS transistor through a SPICE program, the method comprising:
establishing an equation and a variable that determine the driving current characteristics of the MOS transistor;
generating a random number;
converting the random number such that the random number has a value satisfying an equation of a rotated ellipse and determining a variation degree of the variable based on the value of the random number; and
outputting driving current distribution of the MOS transistor by using the equation and the variation degree of the variable.

2. The modeling method of claim 1, wherein the equation and the variable that determine the driving current characteristics of the MOS transistor comprises:
$$Ids = Ueff \times Cox \frac{W}{L} ( Vgs - Vt - \frac{1}{2} Vds ) \times Vds$$
wherein, Ids is driving current, Ueff is effective mobility of an electron or a hole, Cox is capacitance per a unit channel area, W is a with of a gate electrode, L is a channel length of the gate electrode, Vgs is gate voltage, Vt is threshold voltage, and Vds is drain voltage.

3. The modeling method of claim 2, wherein the Cox, Vt, L, and W each serve as the variable in the equation.

4. The modeling method of claim 1, wherein the driving current distribution is defined within one ellipse when the random number has a fixed value.

5. The modeling method of claim 4, wherein a size of the ellipse is changed according to the random number.

6. A modeling apparatus for verifying driving current characteristics of a MOS transistor through a SPICE program, the modeling apparatus comprising:
a computer readable medium, which is encoded with instructions used for executing processes that are performed by a computer to simulate the driving current characteristics of the MOS transistor,
wherein an equation and a variable that determine the driving current characteristics of the MOS transistor are determined by the instructions encoded in the computer readable medium, a random number is generated in the computer readable medium, the random number is converted such that the random number has a value satisfying an equation of a rotated ellipse, a variation degree of the variable is determined based on the value of the random number, and driving current distribution of the MOS transistor is output by using the equation and the variation degree of the variable.

7. The modeling apparatus of claim 6, wherein the equation and the variable that determine the driving current characteristics of the MOS transistor comprises:
$$Ids = Ueff \times Cox \frac{W}{L} ( Vgs - Vt - \frac{1}{2} Vds ) \times Vds$$
wherein, Ids is driving current, Ueff is effective mobility of an electron or a hole, Cox is capacitance per a unit channel area, W is a with of a gate electrode, L is a channel length of the gate electrode, Vgs is gate voltage, Vt is threshold voltage, and Vds is drain voltage.

8. The modeling apparatus of claim 7, wherein the Cox, Vt, L, and W each serve as the variable in the equation.

9. The modeling apparatus of claim 6, wherein the driving current distribution is defined within one ellipse when the random number has a fixed value.

10. The modeling apparatus of claim 9, wherein a size of the ellipse is changed according to the random number.

11. A computer-readable medium, encoded with instructions for verifying driving current characteristics of a MOS transistor through a SPICE program, the instructions enabling a processor to perform the operations of:
establishing an equation and a variable that determine the driving current characteristics of the MOS transistor;
generating a random number;
converting the random number such that the random number has a value satisfying an equation of a rotated ellipse and determining a variation degree of the variable based on the value of the random number; and
outputting driving current distribution of the MOS transistor by using the equation and the variation degree of the variable.

12. The computer-readable medium of claim 11, wherein the equation and the variable that determine the driving current characteristics of the MOS transistor comprises:
$$Ids = Ueff \times Cox \frac{W}{L} ( Vgs - Vt - \frac{1}{2} Vds ) \times Vds$$
wherein, Ids is driving current, Ueff is effective mobility of an electron or a hole, Cox is capacitance per a unit channel area, W is a with of a gate electrode, L is a channel length of the gate electrode, Vgs is gate voltage, Vt is threshold voltage, and Vds is drain voltage.

13. The computer-readable medium of claim 12, wherein the Cox, Vt, L, and W each serve as the variable in the equation.

14. The computer-readable medium of claim 11, wherein the driving current distribution is defined within one ellipse when the random number has a fixed value.

15. The computer-readable medium of claim 14, wherein a size of the ellipse changes according to the random number.
